(19) United States
(12) Patent Application Publication
(10) Pub. No.: US 2002/0073798 A1
(43) Pub. Date: Jun. 20, 2002

(54) Energy absorbing steering column for motor vehicle

(76) Inventors: Patrik M. Ryne, Bay City, MI (US); Melvin Lee Tinnin, Clio, MI (US)

Correspondence Address: EDMUND P. ANDERSON, DELPHI TECHNOLOGIES, INC., Legal Staff, P.O. Box 5052, Mail Code: 480-414-420, Troy, MI, 48007-5052, US

(21) Appl. No.: 09/747,283

(22) Filed: Dec. 20, 2000

(51) Int. Cl. B62D 1/16; B62D 1/18

(52) U.S. Cl. 74/492; 74/493

(57) ABSTRACT

An energy absorbing raked steering column including a rake bracket on a vehicle body, a rake bolt on a collapsible mast jacket of the steering column traversing the rake bracket through a pair of vertical slots in the rake bracket, and a rake clamp for selectively coupling the rake bracket to the mast jacket. The rake bracket releases from the vehicle body for linear translation with the mast jacket in response to an impact on a steering hand wheel on the steering column. An energy absorber includes a pair convex anvils on the rake bracket which are thrust against and pulled across a pair of stationary serpentine metal straps. Forces attributable to plastic deformation of the metal straps resist linear translation of the mast jacket and urge rotation of the rake bracket about the rake bolt. A pair of lateral trunnions on the mast jacket intercept the rake bracket and block rotation thereof to maintain the contact geometry between the convex anvils and the metal straps. One of the lateral trunnions also cooperates with a barb on a cantilever spring on a control

### TECHNICAL FIELD

This invention relates to an energy absorbing steering column for a motor vehicle.

### BACKGROUND OF THE INVENTION

A typical motor vehicle steering column includes a mast jacket, a steering shaft supported on the mast jacket for rotation about a longitudinal centerline of the mast jacket, and a steering hand wheel on the steering shaft at the top of the mast jacket. In a “raked” steering column, the vertical position of the steering hand wheel is adjustable by pivoting the mast jacket up and down about a lateral pivot axis at the bottom of the mast jacket. An apparatus for capturing the adjusted position of the steering hand wheel includes a rake bracket rigidly attached to a body of the motor vehicle having a pair of vertical sides on opposite sides of the mast jacket, a rake bolt on the mast jacket traversing the rake bracket through a pair of vertical slots in the vertical sides thereof, and a clamp for selectively coupling the rake bracket to the mast jacket. In an energy absorbing raked steering column, the rake bracket releases from the vehicle body for linear translation as a unit with a collapsible portion of the mast jacket in response to an impact on the steering hand wheel. An energy absorber resists linear translation of the collapsible portion of the mast jacket and thereby converts into work a fraction of the kinetic energy of the impact. When the energy absorber is interposed between the rake bracket and the vehicle body, force reactions on the rake bracket during linear translation of the collapsible portion of the mast jacket may rotate the rake bracket about the rake bolt. It is desirable to minimize such rotation in order to minimize the negative affect thereof on the performance of the energy absorber.

### SUMMARY OF THE INVENTION

This invention is a new and improved energy absorbing raked steering column for a motor vehicle including a rake bracket on a body of the motor vehicle, a rake bolt on a collapsible upper mast jacket of the steering column traversing the rake bracket through a pair of vertical slots in the rake bracket, and a rake clamp on the rake bolt for selectively coupling the rake bracket to the upper mast jacket. The rake bracket releases from the vehicle body for linear translation as a unit with the upper mast jacket in response to an impact on a steering hand wheel on the steering column. An energy absorber includes a pair convex anvils on the rake bracket which are thrust against and pulled across a pair of stationary serpentine metal straps during linear translation of the upper mast jacket. Forces attributable to plastic deformation of the metal straps resist linear translation of the upper mast jacket and urge rotation of the rake bracket about the rake bolt after rake bracket releases from the vehicle body. A pair of lateral trunnions on the upper mast jacket intercept the rake bracket and block rotation thereof to maintain the contact geometry between the convex anvils and the metal straps and thereby minimize the negative affect of rotation of the rake bracket on the performance of the energy absorber. One of the lateral trunnions also cooperates with a barb on a cantilever spring on a control lever of the rake clamp in retaining the control lever in a locked position corresponding to the rake bracket being rigidly coupled to the upper mast jacket.

### BRIEF DESCRIPTION OF THE DRAWINGS

FIG. 1 is an elevational view of an energy absorbing raked steering column according to this invention;

FIG. 2 is a fragmentary, partially broken-away perspective view of the energy absorbing raked steering column according to this invention; and

FIG. 3 is an enlarged view of the portion of FIG. 1 identified by reference circle 3 in FIG. 1.

### DESCRIPTION OF THE PREFERRED EMBODIMENT

A steering column 10 according to this invention includes a mast jacket assembly 12 consisting of a tubular lower mast jacket 14 and a tubular upper mast jacket 16. The lower mast jacket is connected through a lower bracket 18 to a schematically represented vertical panel 20 of a motor vehicle body for up and down pivotal movement about a lateral pivot axis 22 perpendicular to a longitudinal centerline 24 of the steering column. The upper mast jacket 16 telescopically overlaps the lower mast jacket 14 and is supported thereon for linear translation in the direction of the longitudinal centerline 24 of the steering column. A steering shaft 26 is supported on the upper and lower mast jackets 16, 14 for rotation about the longitudinal centerline 24 of the steering column and is connected to a steering gear, not shown, of the motor vehicle in front of the vertical panel 20. A steering hand wheel 28 is attached to the steering shaft 26 at the top of the steering column.

A rake bracket 30 includes a pair of vertical sides 32A, 32B on opposite sides of the upper mast jacket 16, a rigid web 34 between the vertical sides below the upper mast jacket, and a pair of substantially horizontal planar flanges 36A, 36B. Each of the planar flanges has an open slot 38 therein facing the steering hand wheel. A pair of capsules 40A, 40B are supported on the rake bracket in the open slots 38 with a side channel 42 around each capsule slidably receiving the edge of the corresponding one of the open slots to retain the capsule in the slot perpendicular to the corresponding planar flange 36A, 36B. A plurality of injection molded plastic pins, not shown, prevent horizontal dislodgment of the capsules from the mounting bracket through the open ends of the slots 38. Each capsule further includes a center passage 44 perpendicular to the corresponding planar flange through which the capsules are rigidly clamped to a platform 46 on the motor vehicle body above the capsules by a pair of vertical bolts 48 through the passages and a pair of nuts 50 on the vertical bolts below the capsules.

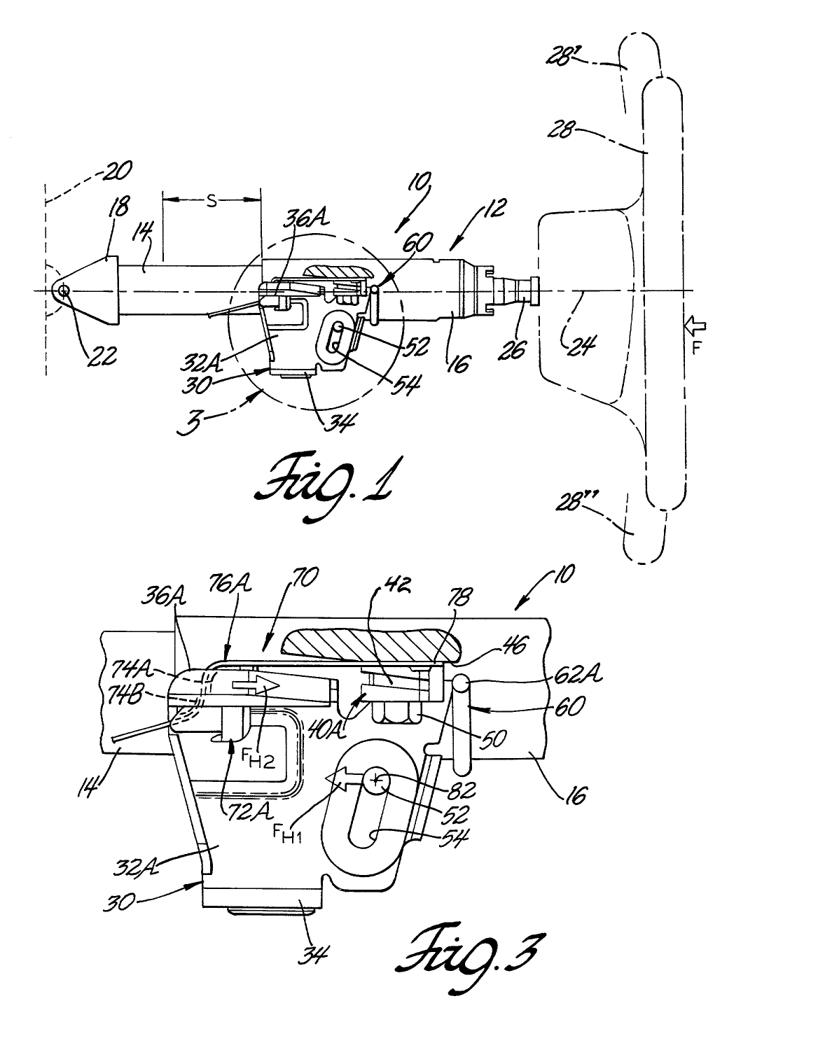

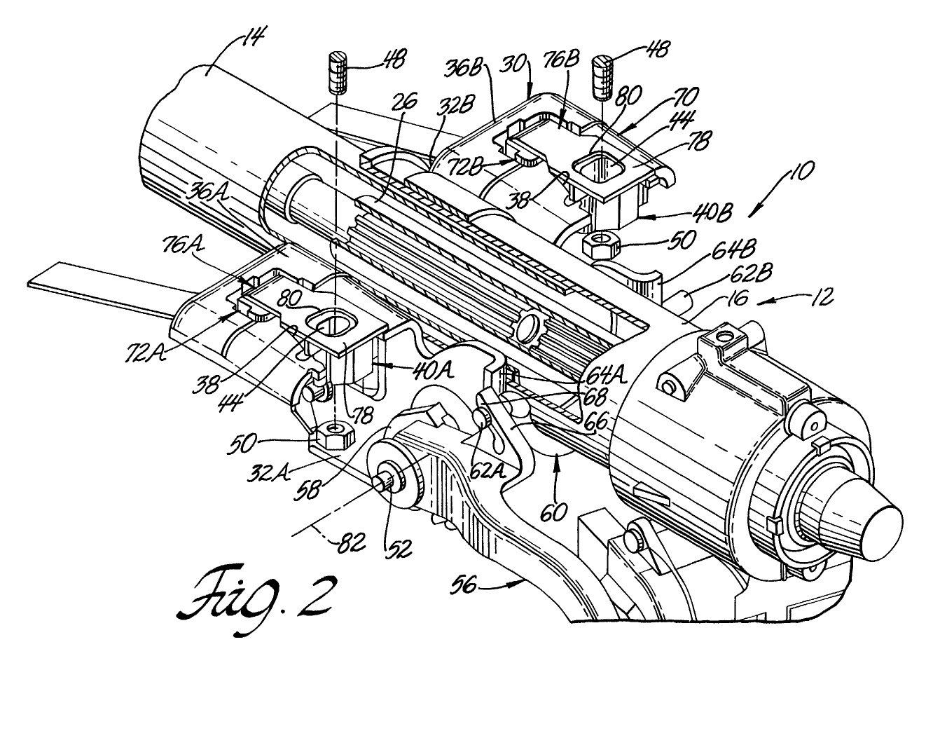

A rake bolt 52 is supported on the upper mast jacket 16 parallel to the lateral pivot axis 22 and traverses the rake bracket through a pair of vertical slots in the vertical sides 32A, 32B of the rake bracket, only a vertical slot 54 in the vertical side 32A being illustrated in FIGS. 1 and 3. The rake bolt moves up and down in the vertical slots as a unit with the mast jacket assembly 12 so that the ends of the vertical slots define schematically represented upper and lower vertical limit positions 28′, 28″ of the steering hand wheel. A control lever 56 is supported on the rake bolt 52 for rotation between an unlocked position, not shown, and a locked position, FIG. 2. A schematically represented clamp 58, FIG. 2, on the rake bolt secures the rake bolt vertically to the rake bracket in the locked position of the control lever to vertically support the mast jacket assembly 12 on the vehicle body in the adjusted position of the steering hand wheel. In the unlocked position of the control lever, the clamp 58 releases the rake bolt from the rake bracket for unobstructed adjustment of the vertical position of the steering hand wheel.

As seen best in FIGS. 2-3, a stabilizer bar 60 is rigidly attached to the upper mast jacket 16 and includes a pair of lateral trunnions 62A, 62B parallel to the lateral pivot axis 22. A pair of vertical flanges 64A, 64B on the vertical sides 32A, 32B of the rake bracket overlap the lateral trunnions throughout the range of positions of the mast jacket assembly 12 defined by the upper and lower limit positions 28′, 28″ of the steering hand wheel. The control lever has a cantilever spring 66 thereon which terminates at a barb 68. As the control lever rotates counterclockwise, FIG. 2, on the rake bolt toward its locked position, the barb 68 and the lateral trunnion 62A cooperate in flexing the cantilever spring 66 upward. When the control lever attains its locked position, the cantilever spring snaps the barb behind the lateral trunnion 62A to retain the control lever in its locked position When force is applied to the control lever urging clockwise rotation thereof from its locked position toward its unlocked position, the barb and the lateral trunnion 62A cooperate to flex the cantilever spring upward again to release the barb from the lateral trunnion for unobstructed pivotal movement of the control lever.

An energy absorber 70 includes a pair of molded plastic guides 72A, 72B in respective ones of a pair of slots in the planar flanges 36A, 36B of the rake bracket in front of the capsules 40A, 40B. Each plastic guide has a serpentine passage therethrough including a pair of schematically represented oppositely facing upper and lower convex anvils 74A, 74B, FIG. 3. A pair of serpentine flat metal straps 76A, 76B traverse respective ones of the plastic guides through the passages therein between the upper and lower convex anvils. An exposed inboard end 78 of each metal strap has a perforation 80 therein over the passage 44 through the corresponding one of the capsules 40A, 40B. The inboard ends 78 of the metal straps are captured between the capsules and the platform 46 on the vehicle body with the vertical bolts 48 traversing the metal straps through the perforations 80. The metal straps are thus rigidly clamped to the vehicle body at their inboard ends.

An impact on the steering hand wheel 28 represented by a schematic force vector “F”, FIG. 1, is transferred from the upper mast jacket 16 to the rake bolt 52 and from the rake bolt to the rake bracket 30. A horizontal component F_{H1}, FIG. 3, of the impact force F applied to the rake bracket at the rake bolt fractures the aforesaid plastic pins to release the rake bracket from the capsules 40A, 40B for linear translation as a unit with the upper mast jacket through a collapse stroke “S”, FIG. 1, relative to the lower mast jacket 14. At the same time, the convex anvils 74A, 74B are thrust against and pulled across respective ones of the stationary serpentine metal straps 76A, 76B to effect plastic deformation of the metal straps at the convex anvils. Reaction forces on the rake bracket represented by schematic reaction force vectors F_{H2} attributable to plastic deformation of the metal straps resist linear translation of the upper mast jacket through its collapse stroke so that a fraction of the kinetic energy of the impact F is converted to work.

As seen best in FIG. 3, because the rake bolt 52 is vertically separated from the planar flanges 36A, 36B, the horizontal vector components F_{H1}, F_{H2} constitute a force couple on the rake bracket urging clockwise rotation thereof about a longitudinal centerline 82 the rake bolt, FIGS. 2-3, after the rake bracket separates from the capsules. Such rotation, if permitted to occur, changes the geometric relationship between the convex anvils 74A, 74B on the rake bracket and the serpentine metal straps 76A, 76B which may negatively affect the energy absorbing performance of the metal straps. The lateral trunnions 62A, 62B, however, stabilize the rake bracket after its release from the capsules by intercepting the rake bracket at the vertical flanges 64A, 64B and blocking rotation of the rake bracket after only a negligible angle of rotation attributable to the dimensional clearance between the trunnions and the vertical flanges necessary for unobstructed vertical pivotal movement of the mast jacket. The geometric relationship between the convex anvils and the serpentine metal straps is thus substantially preserved during the collapse stroke S of the upper mast jacket for optimum energy absorbing performance.

Having thus described the invention, what is claimed is:

1. An energy absorbing steering column comprising:
a mast jacket assembly including a lower mast jacket and an upper mast jacket supported on the lower mast jacket for linear translation through a collapse stoke in response to an impact on a steering hand wheel on the mast jacket assembly,
a lower mounting means operable to mount the mast jacket assembly on a support structure for vertical pivotal movement about a lateral pivot axis at the bottom of the lower mast jacket to adjust the vertical position of the steering hand wheel,
a rake bracket including a pair of vertical sides on opposite sides of the upper mast jacket,
a pair of vertical slots in respective ones of the vertical sides of the rake bracket,
a rake bolt supported on the upper mast jacket for up and down pivotal movement as a unit with the mast jacket assembly about the lateral pivot axis traversing the rake bracket through the pair of vertical slots therein so that the ends of the vertical slots define an upper limit position and a lower limit position of vertical pivotal movement of the mast jacket assembly,
a control lever on the rake bolt pivotable between an unlocked position and a locked position,
a clamp means operable in response to pivotal movement of the control lever from the unlocked position to the locked position to rigidly couple the upper mast jacket to the rake bracket thereby to capture the position of the steering hand wheel relative to the support structure,
an upper mounting means operable to support the rake bracket vertically on the support structure and to release the rake bracket for linear translation as a unit with the upper mast jacket through the collapse stroke thereof in response to the impact on the steering hand wheel,
an energy absorber means operable during the collapse stroke of the upper mast jacket to exert on the rake bracket a force resisting linear translation of the upper mast jacket and urging rotation of the rake bracket about a longitudinal centerline of the rake bolt, and
a stabilizer means operable during the collapse stroke of the upper mast jacket to prevent rotation of the rake bracket about the longitudinal centerline of the rake bolt.

2. The energy absorbing steering column recited in claim 1 wherein the second mounting means comprises:
a pair of planar flanges on the rake bracket perpendicular to respective ones of the vertical sides of the rake bracket,
a pair of open slots in respective ones of the planar flanges facing the steering hand wheel, and
a pair of capsules rigidly clamped to the support structure each having a side channel slidably receiving the edge of a respective one of the pair of open slots so that the capsules support the rake bracket vertically on the support structure and release the rake bracket through an open end of each of the pair of open slots for linear translation as a unit with upper mast jacket through the collapse stroke thereof.

3. The energy absorbing steering column recited in claim 2 wherein the energy absorber means comprises:
a convex anvil on each of the pair of planar flanges of the rake bracket,
a pair of serpentine flat metal straps facing respective ones of the convex anvils each having an exposed inboard end, and
an attachment means operable to rigidly attach the inboard end of each of the pair of serpentine metal straps to the support structure so that during the collapse stroke of the rake bracket as a unit with the upper mast jacket each of the pair of convex anvils is thrust against and pulled across the corresponding one of the serpentine metal straps thereby to plastically deform each of the serpentine metal straps and exert on the rake bracket at the planar flanges thereof reaction forces resisting linear translation of the rake bracket as a unit with the upper mast jacket through the collapse stroke thereof and urging rotation of the rake bracket about the longitudinal centerline of the rake bolt.

4. The energy absorbing steering column recited in claim 3 wherein the stabilizer means comprises:
a pair of trunnions rigidly supported on the upper mast jacket on opposite sides thereof parallel to the rake bolt and juxtaposed respective ones of a pair of vertical edges on corresponding ones of the vertical sides of the rake bracket so that rotation of the rake bracket about the longitudinal centerline of the rake bolt during the collapse stroke of the upper mast jacket is blocked by interference between the pair of trunnions and the pair of vertical edges.

5. The energy absorbing steering column recited in claim 4 further comprising:
a cantilever spring on the control lever having a barb thereon resiliently engageable on a first one of the pair of trunnions in the locked position of the control lever to releasably retain the control lever in the locked position thereof.
